(19) United States
(12) Patent Application Publication
(10) Pub. No.: US 2017/0278202 A1
(43) Pub. Date: Sep. 28, 2017

(54) AUTOMATED PATRON FOOD TAKE-OUT MANAGEMENT

(71) Applicant: Rockspoon, Inc., San Jose, CA (US)

(72) Inventor: Nagib Georges Mimassi, Palo Alto, CA (US)

(21) Appl. No.: 15/333,158

(22) Filed: Oct. 24, 2016

Related U.S. Application Data
(63) Continuation-in-part of application No. 15/278,033, filed on Sep. 28, 2016.
Application No. 15/278,033 is a continuation-in-part of application No. 15/241,079, filed on Aug. 19, 2016.
Application No. 15/241,079 is a continuation-in-part of application No. 15/221,531, filed on Jul. 27, 2016.
(60) Provisional application No. 62/399,331, filed on Sep. 23, 2016.
(60) Provisional application No. 62/313,704, filed on Mar. 25, 2016.
(60) Provisional application No. 62/313,696, filed on Mar. 25, 2016.
(60) Provisional application No. 62/313,693, filed on Mar. 25, 2016.

(51) Int. Cl. G06Q 50/12; G06Q 30/06

(52) U.S. Cl. CPC G06Q 50/12; G06Q 30/0635; G06F 17/30241

(57) ABSTRACT

A system and method automated patron food take-out management, comprising a patron management server configured to accept and provide information about a plurality of venue patrons. A patron profile data store configured to store and provide patron information to other system components. A mobile patron client configured to communicate with patron management server to exchange a plurality of data types related to the order of take-out food items, and a food preparation manager configured to predict preparation times of food items in the presence of a plurality of environmental and mechanical factors. All components working together to automate and simplify the order of take-out food.

### CROSS-REFERENCE TO RELATED APPLICATIONS

The present application claims the benefit of, and priority to, U.S. provisional patent application Ser. No. 62/399,331, titled “AUTOMATED PATRON FOOD TAKE-OUT MANAGEMENT” and filed on Sep. 23, 2016, and is also a continuation-in-part of U.S. patent application Ser. No. 15/278,033, titled, “PROXIMITY-BASED PATRON DISCOVERY AND GROUP CREATION,” and filed on Sep. 28, 2016, which claims the benefit of and priority to U.S. patent application Ser. No. 62/313,704, titled “PROXIMITY-BASED PATRON DISCOVERY AND GROUP CREATION” and filed on Mar. 25, 2016, and which is also a continuation-in-part of U.S. patent application Ser. No. 15/241,079, titled “PROXIMITY-BASED PATRON RELATIONSHIP MANAGEMENT” and filed on Aug. 19, 2016,which claims the benefit of, and priority to, United States provisional application Ser. No. 62/313,696, titled “PROXIMITY-BASED CUSTOMER RELATIONSHIP MANAGEMENT”, and filed on Mar. 25, 2016, which is also a continuation-in-part of U.S. application Ser. No. 15/221,531, titled “AUTOMATED PATRON IDENTIFICATION AND COMMUNICATION MANAGEMENT” and filed on Jul. 27, 2016, which claims the benefit of, and priority to, United States provisional patent application Ser. No. 62/313,693, titled “AUTOMATED CUSTOMER IDENTIFICATION SYSTEM” and filed on Mar. 25, 2016, the entire specification of each of which is incorporated herein by reference in its entirety.

### BACKGROUND OF THE INVENTION

Field of the Art

The disclosure relates to the field of restaurant management, and more particularly to the field of automated customer food take-out management.

Discussion of the State of the Art

It is often difficult for diners to conveniently select a restaurant for takeout or other takeout venue that satisfies both food preferences and time present constraints Additionally, once a restaurant is selected, ordering may be difficult as the patron often does not have menus and does not remember preference particulars. Unfortunately, these factors frequently lead to a patron choosing one or two take-out destinations with which she is familiar and which are known to suit time constraints rather than provide a food of choice or trying new venues.

Present attempts to address these various needs utilize a number of disjointed systems that may or may not integrate with one another, leaving holes in any solution and producing large technical hurdles for a venue operator and inconvenience for both patrons and staff.

What is needed, is a system and method to automatically identify patrons and provide their location and personalized information, assist in communication and navigation for patrons and hosts, facilitate rapid modification of patron information, create opportunities and provide functionality for proximity-based customer service, and assist patrons in group operations like selecting a venue and ordering, including take-out ordering.

### SUMMARY OF THE INVENTION

Accordingly, the inventor has conceived and reduced to practice, in a preferred embodiment of the invention, a system for automated patron food take-out management

According to a preferred embodiment of the invention a system for automated patron food take-out management has been developed which a patron may employ to choose a venue for food take-out based upon factors including food preference and maximal delay time allotted to the pick-up task using a client application present of the patron's mobile device. The system works by polling the patron's mobile client for the patron's current geospatial position and the patron manually entering her destination or choosing a destination from a list of frequently used destinations, for example: “HOME,” or “WORK,” or “FRANK'S PARK,” to name a few possibilities. Delay time may be part of preference data stored in a patron management data store record unique to that patron stored by the system, or may be entered manually if not already available or if the default is not suitable to the current instance. Food type choices may either be retrieved from the patron's patron management data store record or entered manually if not already available or if the patron feels like having something not on the list this time. Using acceptable maximal delay time and food preference data from the patron, up-to-date mean food preparation time data from polled venues, and up-to-date traffic pattern data from 3rd party providers, the system can then generate a list of venue choices that, in general, fulfill both data points and, using mapping APIs show the patron the location of each venue possibly icon encoded for food type or delay range on the patron's mobile client with hover on icon possibly showing brief venue summary and clicking showing more detail including possible display of most current menu among other information some of which may be requested by the patron during system client setup. Once the patron makes a venue and menu item (although order of off-menu items may be allowed based on the venue among other factors) or menu-items choice, the system will communicate with the food preparation management server at that venue for both known preparation times of all ordered items and any additional time offsets due to current kitchen staffing, current venue food order activity level among other known factors. A confirmation offer for the ordered food items, stating a more precise food pick-up time, if needed is then sent to the patron who either places the order or declines and looks elsewhere. A placed take-out order is pushed onto the food preparation queue with all of the correct individual item preparation time offsets to insure that all items are ready just shortly before the patron arrives to pick them up for maximal enjoyment and no waiting.

According to a preferred embodiment of the invention, a system for automated patron food take-out management, comprising: a patron management server comprising at least a plurality of programming instructions stored in a memory and operating on a processor of a network-connected computing device and configured to receive data via a network from a plurality of client devices, the data comprising at least geolocation information and a device identifier, and configured to retrieve patron information from a patron profile data store based at least in part on the device identifier; a patron profile data store comprising at least a plurality of programming instructions stored in a memory and operating on a processor of a network-connected computing device and configured to store and provide patron information to other system components; a mobile patron client comprising at least a plurality of programming instructions stored in a memory and operating on a processor of a mobile network-connected computing device and configured to communicate with patron management server to permit the exchange of a plurality of data types related to the order of take-out food items, the data types comprising at least geolocation information and a device identifier; a food preparation manager comprising at least a plurality of programming instructions stored in a memory and operating on a processor of a network-connected computing device and configured at least to predict the actual preparation times of food items in the presence of a plurality of influencing factors, the influencing factors comprising at least geolocation information and the current state of a food preparation environment; and a food preparation time data store comprising at least a plurality of programming instructions stored in a memory and operating on a processor of a network-connected computing device and configured to persistently store accurate baseline preparation times for a plurality of food items within a food preparation environment, is disclosed.

According to another preferred embodiment of the invention, a system for automated patron food take-out management, comprising: at least a portion of the data exchanged between the patron management server and the mobile patron client are food types served by the take-out food venue, at least a portion of data exchanged between the patron management server and the mobile patron client is the location of take-out food venue, at least one mobile patron client communicates with at least two take-out food venue's patron management servers concurrently, at least a portion of the data exchanged between the mobile patron client and the patron management server is to determine a time delay factor resulting from take-out food pick-up from a route between two points entered into the mobile patron client, at least a portion of the time delay factor is predictively calculated by the food preparation manager resultant from food items ordered on the mobile patron client from a menu of take-out items supplied by the patron management server and current conditions at the venue's kitchen, at least a portion of the take-out items at at least one take-out food venue may be special order and require predictive calculation by the food preparation manager for accurate delay factor, the food preparation manager is used to predictively queue all constituent food items in the take-out order for preparation so as to be ready at the same time and just prior to take-out patron arrival.

According to another preferred embodiment of the invention, a method for automated patron food take-out management, comprising the steps of: receiving, at a patron management server comprising at least a plurality of programming instructions stored in a memory and operating on a processor of a network-connected computing device and configured to receive data via a network from a plurality of client devices, the data comprising at least geolocation information and a device identifier, and configured to retrieve patron information from a patron profile data store based at least in part on the device identifier, a device identifier and device geolocation information from a patron mobile client via the network; retrieving, using a patron profile data store comprising at least a plurality of programming instructions stored in a memory and operating on a processor of a network-connected computing device and configured to store and provide patron information to other system components, a plurality of patron information based at least in part on the received device identifier; receiving, at the patron management server at least two endpoints comprising a current location and an intended destination and a request for venues serving specific take-out food types from the patron mobile client; calculating, employing a food preparation manager and data from a food preparation time data store, preparation times of ordered take-out food items accounting for the current situation in the preparing kitchen to increase accuracy; and coordinating food item preparation start times using the food preparation manager such that all food items come out of preparation at the same time and take-out food orders are ready very shortly prior to patron pickup arrival, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram of an exemplary system architecture for automated patron identification and communication management, according to a preferred embodiment of the invention.

FIG. 2 is a diagram of an exemplary architecture of system for predictive restaurant table management, according to an embodiment of the invention.

FIG. 3 is a flow diagram illustrating an exemplary method for automated management of patron take-out orders according to a preferred embodiment of the invention.

FIG. 4 is an illustration of an exemplary patron's mobile client screen for take-out order completion according to a preferred embodiment of the invention.

FIG. 5 is a flow diagram illustrating an exemplary method for accurate food item preparation time prediction, according to a preferred embodiment of the invention.

FIG. 6 is a block diagram illustrating an exemplary hardware architecture of a computing device used in an embodiment of the invention.

FIG. 7 is a block diagram illustrating an exemplary logical architecture for a client device, according to an embodiment of the invention.

FIG. 8 is a block diagram showing an exemplary architectural arrangement of clients, servers, and external services, according to an embodiment of the invention.

FIG. 9 is another block diagram illustrating an exemplary hardware architecture of a computing device used in various embodiments of the invention.

### DETAILED DESCRIPTION

The inventor has conceived, and reduced to practice, in a preferred embodiment of the invention, a system and method for automated patron identification and communication management.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features.

Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

As used herein, “host” refers to any member or members of an establishment's wait staff or other customer service-oriented personnel whose job duties may include: taking a restaurant patron's food order at or near the time the patron is seated; bringing the prepared food that has been ordered to the correct restaurant patron for eventual consumption by that patron; polling the restaurant patron for satisfaction opinions and confirm that the patron and their party have vacated the table at the end of their stay, and may be used to refer to waiters or waitresses, food preparation staff, managers or administrative staff, or any other employees or members that may interact with a patron or patrons.

### Conceptual Architecture

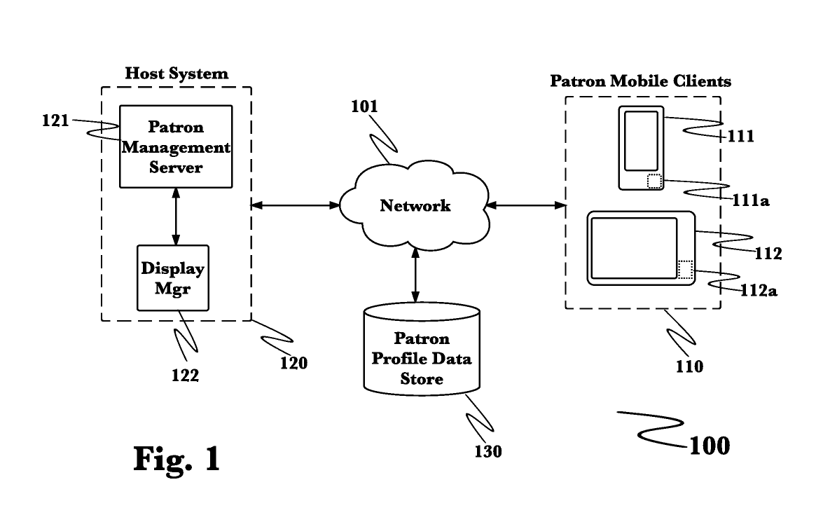

FIG. 1 is a block diagram of an exemplary system architecture 500 for automated patron identification and communication management, according to a preferred embodiment of the invention. According to the embodiment, a plurality of patron clients 110 such as (for example, including but not limited to) a smartphone 111 or tablet computing device 112 may connect to a network 101 such as a WiFi local area network, cellular wide-area network, short-range wireless interconnection protocol, or other data communication network according to the capabilities or intended use of a particular device. A patron client may comprise a location beacon 111a, 112a, that may utilize available network connections or global positioning to determine a client's geolocation through various software means (for example, using GPS satellites or cellular network triangulation, indoor positioning systems such as Wi-Fi positioning, as are commonly utilized in such devices) as well as to detect other location beacons operating on nearby clients. For example, a patron client 111 may detect a beacon operating on a host device 120 when they are in close proximity (such as within twenty feet, or other proximity thresholds according to a device's particular configuration or capabilities), and may use this beacon information to drive operation. Detected beacon information may then be provided via network 101 along with a client identifier token, for example a client's hardware media access control (MAC) address, which is generally unique to a particular client's network interface and may therefore be used to uniquely identify a particular client, or a user ID such as a patron's user name within a software application or service, or their contact information stored on the client, or other form of information that may be used to uniquely identify a patron via their client. To identify a host system when detected, a variety of identification tokens may be used such as a host's universal user ID (UUID) that may identify “this is a host system using the beacon service of your provider” to the patron client (and may be shared by all hosts within a restaurant or within an application to facilitate smooth operation and to ensure patron devices only wake and capture information when appropriate), or a unique host-specific ID that may be used to identify the particular host when detected (for example, some beacon technologies utilize a shared UUID that describes, for example, “this is a host using the app” so the patron client's application knows to capture this beacon information, as well as unique “major” or “minor” ID strings that uniquely identify a specific device within a group using a single UUID). Other forms of client identifier may include (for example) an IP address identifying the device within the scope of a particular network, a device's “friendly name” as is commonly used in BLUETOOTH™ operations, a client telephone number, or a unique username or similar text-based identifier, for example as may be chosen by a user within a software application and used within the context of interactions with that particular software service or product. In some embodiments, a combination of identifier tokens may be used.

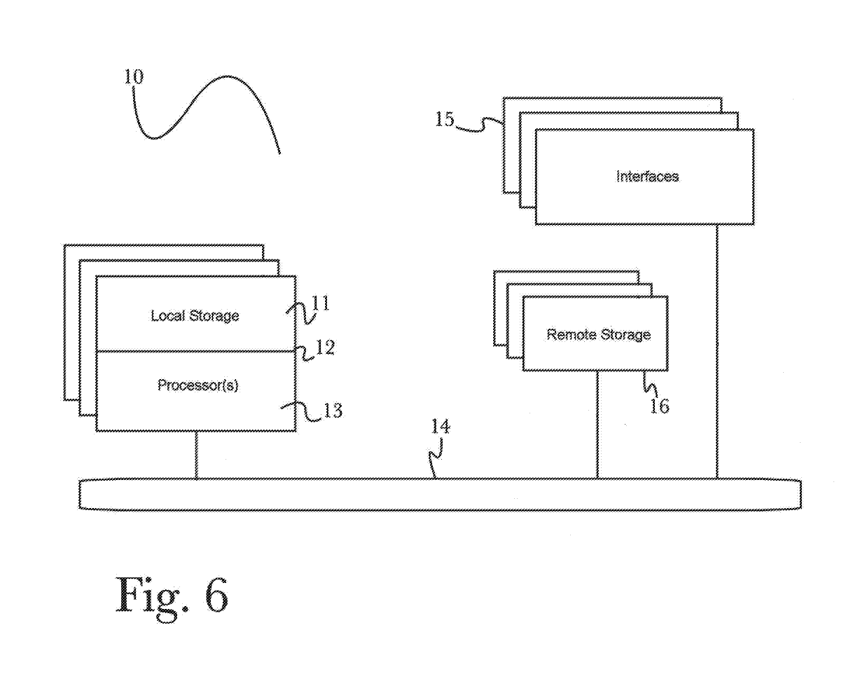

Client identifiers and geolocation information may be received by a host system 120, which may communicate with a patron management server 121, which may be a remote server communicating via the Internet or other wide-area network, or may be a local server on a local-area network, or may be a decentralized server operating across multiple devices (for example, using host mobile devices to operate the software functions of server 121) in direct networked communication (for example, according to the specific nature or arrangement of a network 101, described above) to receive a client identifier and query a patron profile data store 130 for patron information based at least in part on the received identifier. For example, a patron's account information stored in a patron profile data store 130 may comprise their contact information, a photograph, survey results, and/or a list of known devices with their corresponding client identifiers (whether MAC addresses or otherwise). In this manner, a received client identifier may be anonymous and secure with regard to other networked devices or potential information leaks, but within the scope of the appropriate patron profile data store 130 it may be used to uniquely identify a patron and retrieve any stored information. Patron management server 121 may then direct the operation of a display manager 122, that may for example comprise a video adapter operating on a mobile device (such as a smartphone, tablet computing device, or other computing device comprising at least a processor 41 and memory 43 as described below in FIG. 6 and capable of receiving software instructions and operating a display manager) to present patron information to a host user for viewing or interaction, for example to present a patron's username (or other identifying information), contact information, a profile image such as a photograph of the patron to visually identify them (for example, to pick out a particular patron in a crowded room), or other information.

In an exemplary use case of this system a patron may have accounts on the systems of multiple food venue chains and local venues. The patron may then use a software application on a smartphone 111 which allows her to poll all area host system 120 subscribed venues for take-out choices providing the amount of delay she feels acceptable assuming a route between pre-entered current and destination locations. The patron may configure an account within the application, for example, including a username and their device's MAC address and network capabilities (including geolocation capabilities). For example, a patron may install a provider's application on their client 110 and authenticate their user information during an initial setup for the application, and from that point forward the application may have permission to operate in the background of their client, passively capturing beacon information for hosts using the provider's application as appropriate. The client application 110, in the use as a food take-out resource can then use these account data to request placement pre-order of food for take-out. The system 120 then uses its food preparation time prediction capabilities and kitchen food preparation pacing functions 200 to predict fulfillment of the food order in the allotted time and control preparation of the ordered food items for on-time readiness and optimal enjoyment at the time of patron arrival. When the patron approaches a restaurant with the application running (either in the foreground of their device or in the background, such as a closed but configured application installed on their device), their client may detect a nearby location beacon from a host device when they are near a participating restaurant (for example, if there is a restaurant host standing near the entrance to seat incoming customers, their device's beacon information may be detected). Detected beacon information may then be provided to a patron management server 121, which in turn uses the beacon information to retrieve the patron's information to provide it to hosts for use in serving the food take-out patron. A host working at the restaurant may be operating a mobile POS on their own smartphone or tablet, which may then receive the patron's information (optionally, only when the patron is within a specified range or for a specified duration, to prevent “false positives” such as when a patron walks or drives past a restaurant). To address various situations where there may be multiple patrons or multiple hosts (or both), patron information may be presented in an ordered list such that most-recent or most-proximal patrons are presented in an ascending or descending order, allowing a host to quickly identify which patrons are nearest them (generally, the patrons at the table they are currently serving) to avoid confusion. For example, a patron may be nearby two or more hosts so it may not initially be clear which host is serving them. By presenting the patron's information to both hosts, they may manually identify the patron (such as by a photograph shown with their information) and continue operation. This also avoids confusion when a patron may walk past multiple hosts, or when multiple patrons enter simultaneously.

The host may then view the patron's information on their device, and may immediately have details such as dietary requirements or allergies, patron name or title, or any specific preferences such as a “usual drink order”, favorite host, or other such information that may be configured and stored in a patron profile data store according to the embodiment. This enables the host to begin serving the patron with a level of familiarity otherwise not possible, making the overall dining experience more efficient for both parties and allowing the patron to enjoy the sense of being a “regular”, such as being addressed by name and having their preferences already known. In some embodiments, a host's schedule may be cross-referenced with a patrons broadcast information (e.g. favorite host) and may be assigned to the patron. In some embodiments, host information may be presented to a patron via their mobile device, such as to view the host's name, contact or demographic information, particular job skills or specialties, or other information. This may be utilized (according to a particular patron or venue configuration, for example a user may be permitted to enable or disable functionality for their client or a venue may enable or disable functionality for all patrons) to provide a patron with information on their host to enhance their experience such as by enabling more familiarity during conversation, or allowing a patron to identify a host that will be particularly suited to their preference (such as a host that is familiar with their particular dietary preferences, or is skilled in taking custom orders), as well as to enable the configuration of custom preferences on a per-host basis, such as to specify a “favorite host” or to select hosts that a patron may wish to avoid. Optionally, satisfaction survey information (if available) may be utilized and attributed to a particular host (generally, the host with which a patron most recently interacted) and used to automatically determine such patron- and host-specific configuration (however, a patron or venue may override these automatic values as needed). Additionally, patrons may be presented with a survey or brief feedback interface during or after their transaction, such as a simple “thumbs-up” or “thumbs-down”, or a detailed feedback or review according to a particular configuration. Survey or feedback data may also be compared to a transaction's details, such as items purchased or ordered, tips left, hosts interacted with, or other information that may be associated with a review to enhance feedback information with contextual data on the transaction being reviewed. Feedback may also comprise a “referral” functionality, wherein patrons may be encouraged or incentivized to refer others to a venue or to recommend their particular purchase or host. Patrons may also be presented with a greeting or advertisement from hosts or venues they like, for example when they come within a specified range, as described below.

In another exemplary use case, multiple patrons may arrive at a restaurant and a host may be presented with their individual information in an ordered fashion, for example sorted by distance from the host or arranged to reflect their seating at a table (for example, in a radial arrangement about an on-screen table, and rearranging in real-time as the host moves so that the display constantly mirrors the patrons' physical locations relative to the host). In this manner, a host may easily keep track of patrons within a party and seating arrangements, reducing the possibility of ordering errors even during periods of high activity.

A further exemplary arrangement may utilize proximity information to enable a “pre-order” feature, wherein patrons may be allowed to place orders or purchase products or service in advance while their location information is used to periodically update their ETA to a venue. This may be further used to enable more precise tracking of patrons who, (for example) order food at a restaurant before arriving, so that when they arrive their food is already prepared and they may dine immediately, or to enable a venue's food preparation staff to view a patron's ETA to determine when to begin preparing certain items. Pre-orders may also comprise reservations (according to a venue's particular configuration), and reservations may optionally present a patron with an option to select an “occasion” such as “business meal” or “birthday”, to further customize their experience.

A further exemplary use case may be a “walk-by” interaction, wherein a patron may be notified if they pass within a configured range of a venue, for example so that they may be presented with an advertisement or greeting from a venue they frequent or from a particular host they like (as may be determined from previously-received review information, as described previously).

According to some arrangements, a display manager 122 may also be configured to receive user interaction, and to optionally direct the presentation of information based on this interaction, or provide at least a portion of the interaction to a patron management server 121 for use. For example, in some arrangements a host may be able to rearrange patrons on a display using a “click-and-drag” or “tap-and-drag” type interaction with visual indicia on their device, such as a patron's profile image (if available) or an icon or similar visual placeholder for a patron, such as to correct any errors in positioning about a table or to manually group patrons into parties such as when two groups are seated at a single table (such as at a bar where seating may be shared, or in a restaurant where a table may be splitting the bill) or one group is seated at multiple tables (as with very large parties). In another example, a host may be able to modify some or all of a patron's profile stored in a patron profile data store 130, for example to update a patron's contact information or allergen information. In such an arrangement, the host's interaction information may be used by patron management server 121 to direct a patron profile data store 130 to update the relevant information based on the interaction, and may optionally display a notification to the host or patron (or both) to notify them of the update. For example, a patron may notify their host that they have new dietary requirements, the host may then input these new preferences into their device, and then the patron may be notified on their device of the change and prompted to review and confirm the change. Additionally, a host may be notified if a patron updates their information manually via their client, such as if a patron updates their preferences while they are dining. For example, a patron who is currently eating may update their preferences to reflect a new “dislike” based on their current dish, which may be displayed to the host. This may prompt the host to check in with the patron and assist them with the unsatisfactory item proactively, instead of requiring the patron to wait for the host to return for another reason and then voice their issue. In this manner, errors may be reduced by enabling a patron to directly view and confirm or deny their patron information as it is modified, and any changes made to information may be made immediately known to both patron and host to facilitate proactive interaction and minimize the risk of errors.

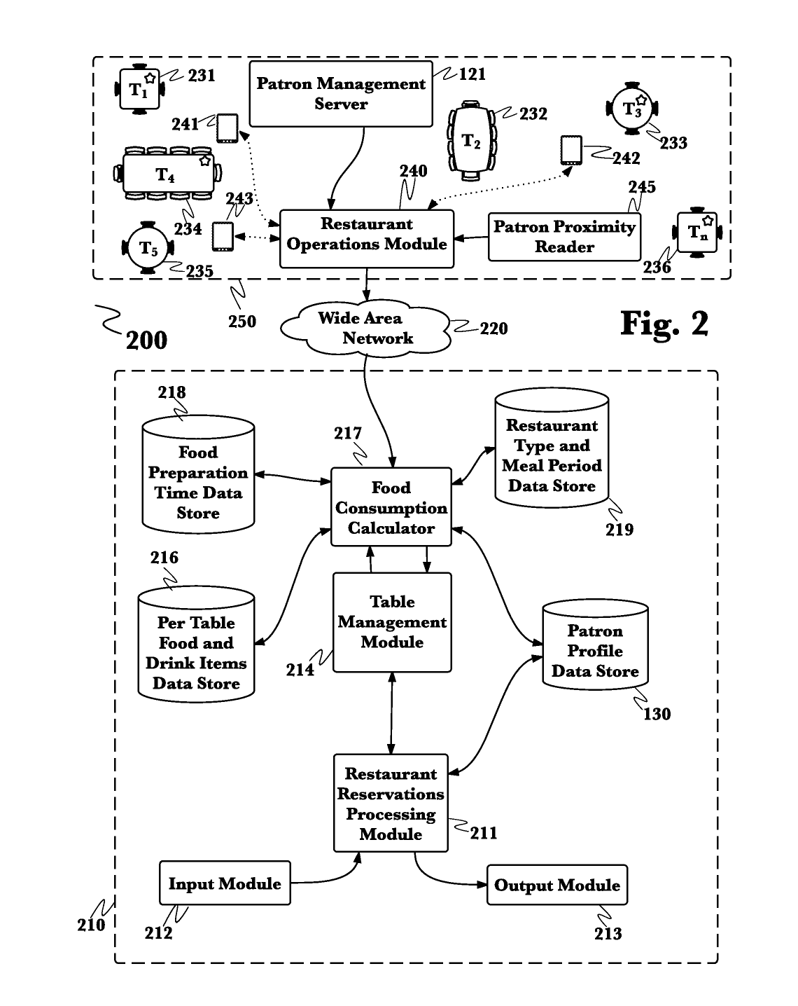

FIG. 2 is a block diagram of an exemplary system architecture 200 for predictive restaurant table management, according to a preferred embodiment of the invention. According to the embodiment, both confirmed and predicted table occupancy may be tracked within the table management module 214. Data on actual table occupancy may be at least partially derived from observations of hosts employed by the restaurant, who may monitor tables that are actually available 132, 135 or occupied by patrons 231, 233, 234, 136 using a plurality of host mobile devices 241, 242, 243 connected to a restaurant operations module 240. Accurately predicting when a reserved table will become available involves many factors. Freeing a table when it has been reserved but the time of the reservation has passed may be easiest to calculate; a policy, stated or unstated, can be implemented that reservations expire at a certain time limit past the reserved time and parties arriving past that time may not be accommodated. Such policies can lead to significant ill will among patrons that may impact business performance, and may make setting a time period for such a policy a delicate task. The advanced program logic of a table management system 214, which comprises programming instructions configured to operate machine learning, can over time determine a time period that optimizes the satisfaction of a restaurant's patrons and table utilization, optionally utilizing follow-up questions on a restaurant interaction device (not depicted) that a patron is using to communicate with the restaurant, which can then be adapted to this type policy. Related to a general time period limit, there may be patrons who consistently arrive early or who consistently arrive late. According to the embodiment, software programming instructions operating on a processor of a restaurant reservation processing module 211 may be configured to track a variety of data pertaining to individual patrons 215 such as (for example) preferences and habits, much of which is accumulated passively during patron visits and which, in conjunction with the logic of the table management module 214, may be used to better serve patrons and maximize table utilization within a restaurant. For example, the probability of certain patrons to arrive early, based upon previous check-in times at a hostess station 244 or the timestamps of previous proximity readings between the patron's restaurant interaction device and a receiver in the restaurant's lobby 245, might be used to place them at a table predicted to be available earlier than their reservation and to shift them, at least partially, out of a time slot of known very high occupancy, possibly allowing more reservations to be taken and reducing the wait time of those patrons. Patrons known to habitually arrive late may have the time of table availability shifted to a later time, reducing the amount of time a table is vacant and, again potentially increasing restaurant capacity during times of high occupancy. The description above discloses two related examples, the early arriver and the late arriver, and how the invention might use those data to improve restaurant operations. It should be appreciated that there may be many other potential improvements brought by the system, and that the examples chosen are intended for simplicity of explanation and to relate one way in which the parts of the invention might work, and are in no way meant to be exhaustive.

A patron management server 244 may be used to identify and track patrons, and to query a patron profile data store 215 for patron information such as including (but not limited to) contact information, a photograph, survey results, and/or a list of known client devices with their corresponding device identifiers (whether MAC addresses or otherwise). Patron management server 244 may receive patron identifying information from a patron's mobile client and use this information to uniquely identify a patron and retrieve any stored information.

Reliably predicting when an occupied restaurant table will become available, to the point where that prediction can be used in a reservation process, involves analysis of many factors, some of which require complex calculation to be accurate. Examples of the factors that may need to be considered may include when a table is first occupied (which may be tracked by a table management module 214), food and drink items ordered by patrons at a table (which may be stored by a per-table food and drink items data store 216), or time needed to prepare food items, which also increases service efficiency as all items are more likely to be ready to be served at the same time. Food preparation time information may be stored in a food preparation time data store 218. The type of restaurant, geographical location of the restaurant and time of day or meal period can all have profound influences on the time that needs to be allotted for consumption of a particular menu item. More formal or elegant venues have much different consumption profiles than do more family oriented venues or quick-stop type sit down restaurants. Otherwise identical restaurants in an urban location and a more rural location would have different consumption time profiles. An identical item served during the lunch period or for dinner might differ significantly in consumption time. Such restaurant-specific consumption time data may be stored in a restaurant type and meal period data store 219. The eating characteristics of individual patrons may also, either by themselves or with other dining guests, greatly affect the consumption time of a meal. These patron specific consumption data are stored by a patron profile data store 215. These menu item, restaurant location, and patron eating habit factors may be analyzed by the programming logic of a food consumption calculator 217, the results fine-tuned by machine learning algorithms as well as by observations and ordering data entered via a host mobile device 241, 242, 243 and received via a restaurant operations module 240 to arrive at a progress calculation that may then be used by a table management module 214 to predict a time a given table should become available. Table management module 214 may then supply the status of a restaurant's tables to a restaurant reservations processing module 211 to aid in reservation creation.

The analytics and machine learning capabilities of the food consumption calculator 217 are also critical in predicting food preparation time for take-out patrons, who, in several ways present stronger demands for just-in time food readiness than do dine-in, seated, patrons. When take-out patrons arrive, they may enter with the expectation of picking-up their ready food which is the correct order and that food to be out of the kitchen hot. They are often busy, possibly stressed, at the time of pick-up and may be on a very tight time budget. Deviation from the expected ideal, that being that the venue staff at least seem to be expecting them, the food is ready when they get to the counter and since they are “on-time” that it is hot as if just brought out of the kitchen for their arrival, not cold like it has sat for a long period, maybe even part of someone else's cancelled order, may meet with disproportionate, severe degradation of the venue's status and chance of re-visit in the future. A large part of the function of the host system 210 is to track congestion and response times within the venue which affect food preparation times 218, 217 as well as table usage 216, 214, 219. Among a great many other factors not listed but for which the invention is designed to incorporate, the time needed to prepare a food item may have a baseline time period, for example: a particular type of pasta needs to be boiled for 6 minutes, the water takes 5 minutes to come to a boil, and draining the cooked pasta takes 6 0seconds, so the cook time for that pasta is 12 minutes; there are, of course hundreds of similar, knowable preparation times that can be stored in a data store 218. This time figure of 12 minutes, however, may be lengthened by number of other items being concurrently prepared, number of widely different items being prepared, number of burners and pots and drain areas in the kitchen and by size of the kitchen staff at a given time. These factors affect the preparation of every food item to some extent, more so when a venue is cooking “near capacity” than when it is less busy. It is the function of at least some of the programming of the food consumption calculator 217, which either knows the numbers for the mentioned factors, or which may calculate them from the available food preparation data, to accurately predict a pacing factor for each food item to be prepared, that is to say the time to be added to (or, on some rare occasions subtracted from) the baseline food item preparation time stored in food preparation time data store 218 for that item. Predictions made by food consumption calculator may be used two fold. First prediction allows an accurate food preparation delay time to be included in calculation of a food take-out order confirmation, which a patron may then reject if the time figure exceeds her available time window. Second, upon order placement for a particular food, the food consumption manager 217 may then queue the preparation of each constituent item in the recipe such that they are ready for combination concurrently and the entire take-out food order is ready and packaged to closely coincide with the arrival of the patron. This insures the food is kitchen hot and optimal enjoyment be the patron, making return visits to the venue more likely.

While the illustrated arrangement shows the invention in a network-connected configuration 210, 220, 250 this depiction does not imply that the invention is dependent on such an arrangement. In fact, the invention could follow any topology known to those skillful in the art. Also it can be easily seen that the relationships and connections between the components of the system are not always optimal for the roles given to them in the examples, the diagram is drawn to show the relationships and connections in the most clearly drawn manner and do not always depict the most logically direct mode.

### DETAILED DESCRIPTION OF EXEMPLARY EMBODIMENTS

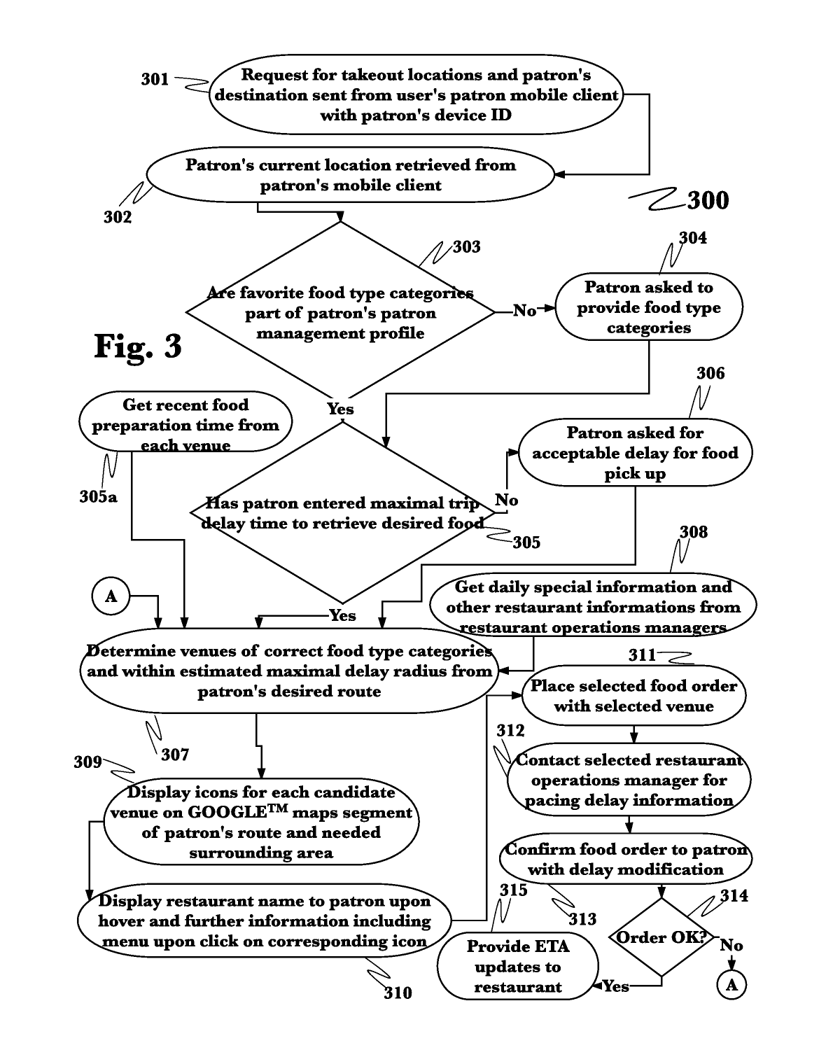

FIG. 3 is a flow diagram illustrating an exemplary method 300 for automated management of patron take-out orders, according to a preferred embodiment of the invention. In an initial step 301, a patron client 110 (that may be any appropriate electronic device, generally capable of some level of geolocation and network communication, for example a smartphone 111 or a tablet computing device 112) may be used to request a list of possible take-out venues within a certain predicted time delay range from a route between a current location point, which may be co-broadcast from the patron's venue client 110 or may be retrieved from the patron's client device 110 by the host system 120 depending on the embodiment 302, and a manually entered or list chosen destination point. At the same time the patron's client may transmit a device identifier for the client such as a hardware address or a software user identifier. This information may be sent to a patron management server 121, along with the patron client's identifying information such as a hardware address or a software user identifier. In a next step 303, patron management server 121 may retrieve patron information from a patron profile data store 130, such as favorite food type categories, allergies, and food dislikes based on the received identification information. The patron may be asked to provide some desired food type categories for take-out, or specific foods desired for take-out if none exist in their stored patron profile 304 and may have the option to override the stored values, if desired. It is also possible that the patron has not entered a maximal trip delay time for the pick-up of take-out in general or this trip specifically 305. The patron therefore may be asked to enter this time factor 306, or be presented with the option to override, even change a stored default found in their profile, if present. If more than one route exists between the patron's current location (B) and their intended destination (C) the patron may be shown a may with the routes demarcated and asked to choose their intended one (not shown). Once the types of food, the maximal delay over the normal trip time and route are known, take-out venues offering the correct food types and predictively calculated within the correct delay radius are identified 307. The polling of take-out venues may occur in multiple ways, two such methods may be to have an independent regional host system that acts as an agent for several venues and responds to queries such as the take-out request here, integrating data 308, possibly received asynchronously, from the member venues and displaying venue icons 310, possibly encoded for food type or delay time range on a map 309, passing control to the individual venue host system when an order is placed. In an alternate embodiment, the host systems for each venue offering take-out may intercept and process take-out queries such as that disclosed here and may then their own responses which are then integrated and placed on a map by software within the patron's client 309 and directly displaying venue specific summary information 308 and in depth information 310. There are, of course other methods by which the information from several independent venues might be aggregated and displayed that are known to those skilled in the field. The invention may be programmed to use a plurality of methods and should not be confined by the illustrative examples given. Upon the patron placing an order for specific food items 311, predictive analytics that encompass factors such as but not limited to: the known base cook times of the ordered items, retrieved from the host system's food preparation time data store 218, current kitchen preparation equipment capacity used, and kitchen staffing levels 312 predictively calculated from the host system's 120 food consumption calculator 217; may be used to further refine, when combined with area traffic condition data, available from third party sources, the highly accurate predictive total delay for pick-up of the take-out food in an order receipt confirmation message sent from the intended venue host system to the patron's client 313. The client may then place the order 314 at which time the patron's client may provide ETA updates 315 to the venue host system 120, or the patron may decide to try another venue A-A and may begin the selection process over 307.

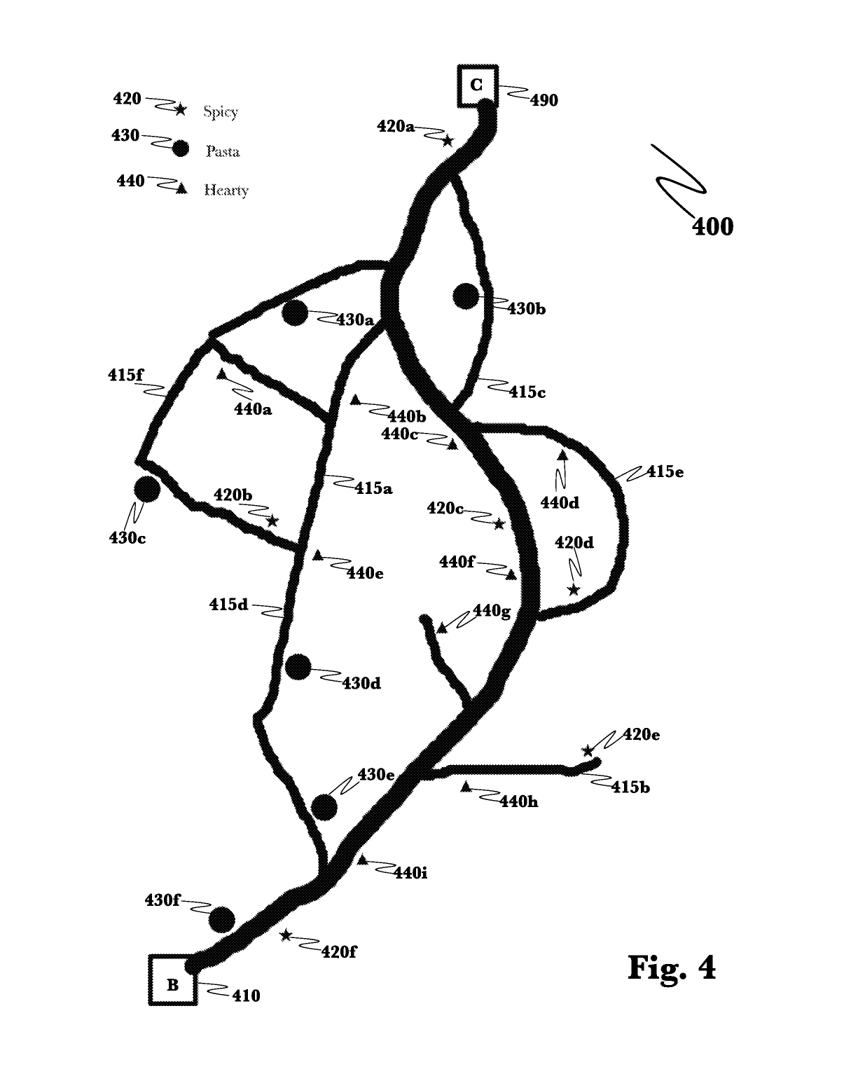

FIG. 4 is an illustration of an exemplary patron's mobile client screen for take-out order completion 400 according to a preferred embodiment of the invention. In this screen illustration the current location of the patron as retrieved by the patron's client by using GPS satellites or cellular network triangulation, indoor positioning systems such as Wi-Fi positioning, as are commonly utilized in such devices is used as a terminus 410 (B) for a map of take-out venues with the patron entered destination the other terminus 490 (C). Other roads in the area that are within the client's requested delay time period radius and where possible take-out venues matching the patron's stated food type category choices 420, 430, 440, may also be displayed on the map 415a, 415b, 415c, 415d, 415e 415f. The patron has selected “Spicy” 420, “Pasta” 430, and “Hearty” 440 as desired food type choices. These choices may be defaults pre-stored in the patron's data store record 130 or may have been selected during the ongoing session. Venues offering a particular desired food type may be marked with a corresponding icon on the map. For example, “Spicy”-420: 420a, 420b, 420c, 420d, 420e, 420f ; or “Pasta”-430: 430a, 430b, 430c, 430d, 430e, 430f ; or “Hearty”-440: 440a, 440b, 440c, 440d, 440e, 440f, 440g, 440h, 440i. The use of just three food type choices is for example only and does not reflect a limitation of the invention which is designed to show a variable number of choices according to situational dynamics. The patron may hover over any of these icons of interest to get summary information such as but not limited to: venue name, address, a slogan and a thumbnail image. Clicking on the icon may open a window including more in depth venue information, offer a complete take-out menu, and may display the daily specials. Selection of a food item or other marker at this stage may bring the patron to the venue's normal dedicated pre-order/take-out order process for further activity.

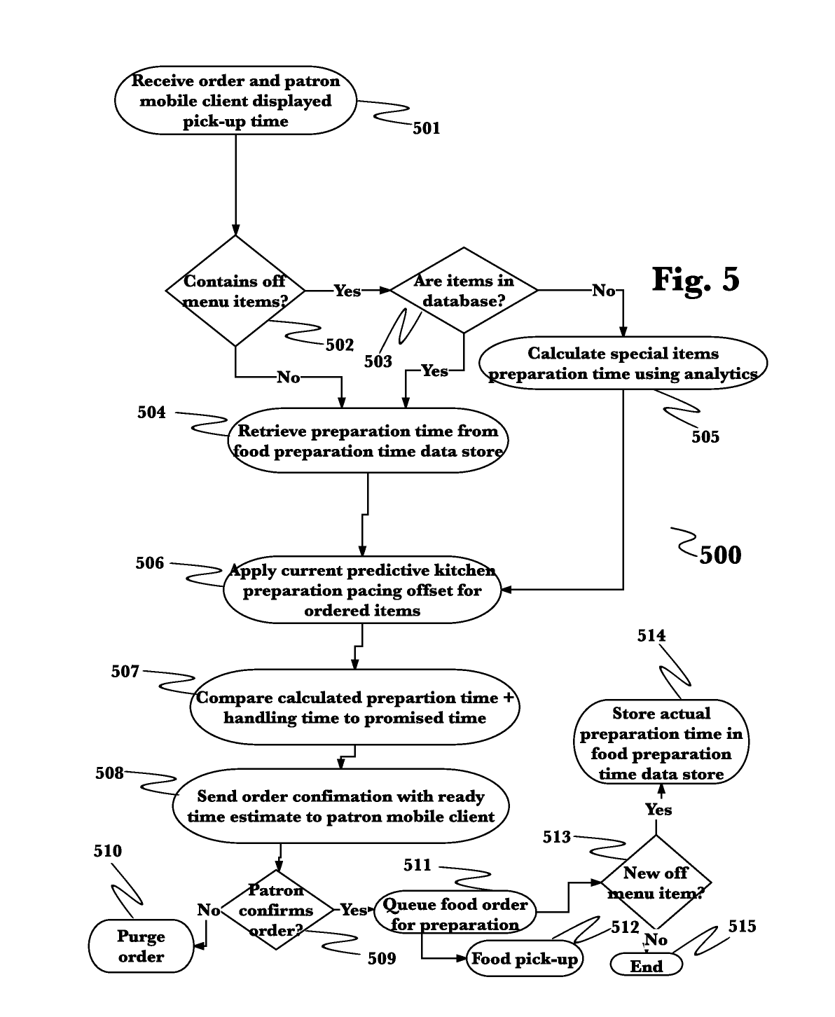

FIG. 5 is a flow diagram illustrating an exemplary method for accurate food item preparation time prediction 500, according to a preferred embodiment of the invention. One of multiple capabilities that makes the invention a significant advancement over prior art is the use of machine learning and analytics applied to the field of restaurant management including but not limited to the accurate to usefulness predictive calculation of food preparation time based on a plurality of variables both within the kitchen and outside of it as known to those skilled in the art. In an embodiment of this capability food preparation time calculation may be used to accurately and predictively fulfill an order for take-out food items such that they are ready for pickup at a promised time and are just out of the kitchen hot when the patron arrives. Here an order for particular take-out food items is received 501 by the venue's host system 120 which determines whether, as some venues will allow, any food dishes are off-menu or special order 502, many will not be, 504, sometimes a special order item may be requested and those items have not been made a sufficient number of times to have preparation times committed to the food preparation time data store 218. Under this situation 303, the predictive abilities of the food consumption calculator 217 may be used to predictively estimate a preparation time 505 for the new food item possibly though the partial use of a small number of previous preparations locally stored in the food consumption calculator or though the preparation times of one or more similar dishes or constituents of the new dish known to the module 217. Normally, the take-out items will be choices from the menu or, if special order will have baseline preparation times found in the data store, those preparation times will then be retrieved from the food preparation time data store 504.

Many environmental factors, including, but not limited to how busy venue is, level of kitchen staffing, and other food items currently in preparation, that may greatly affect the preparation time a food order 506. The machine learning and analytic capabilities of the food consumption calculator are at least partially designed for to account for these factors and provide accurate predictive food readiness time estimates which may be used to confirm that take-out food orders will be ready prior to arrival of a patron for its pick-up 507. Predictions may be used to confirm that the promised pick-up time is attainable before a take-out order confirmation is sent to patron 508. Once the patron confirms that she wants the take-out order 509, the food consumption calculator 120 may be used to queue the constituent food items for the order for the proper start times for optimal kitchen efficiency and so that all food items are ready and hot 511 when the patron arrives 512. If the take-out order is a new item 513 then its preparation time may be added to the preparation time data store 514 otherwise the preparation process ends 515. Occasionally, the patron may not confirm the take-out order for a reason 509, then the order may be purged from the system and no action may be taken 510.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Referring now to FIG. 6, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS CPU™ as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 6 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

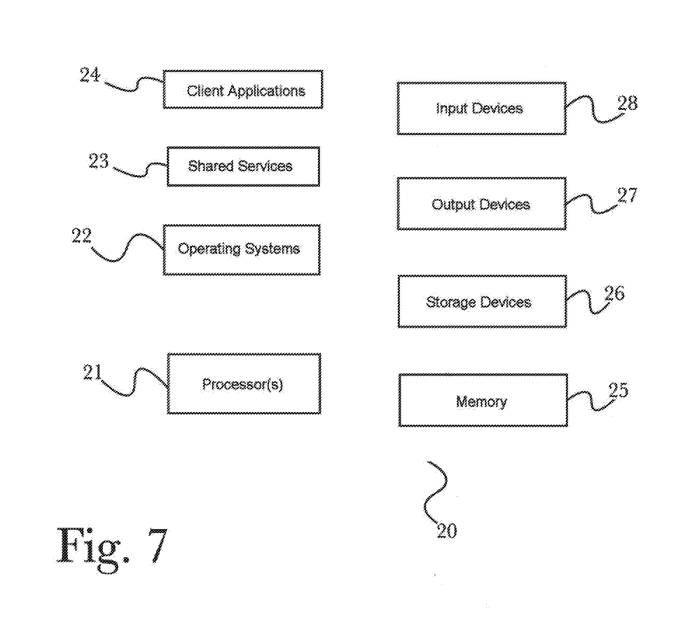

In some embodiments, systems according to the present invention may be implemented on a standalone computing system. Referring now to FIG. 7, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 6). Examples of storage devices 26 include flash memory, magnetic hard drive, CD-ROM, and/or the like.

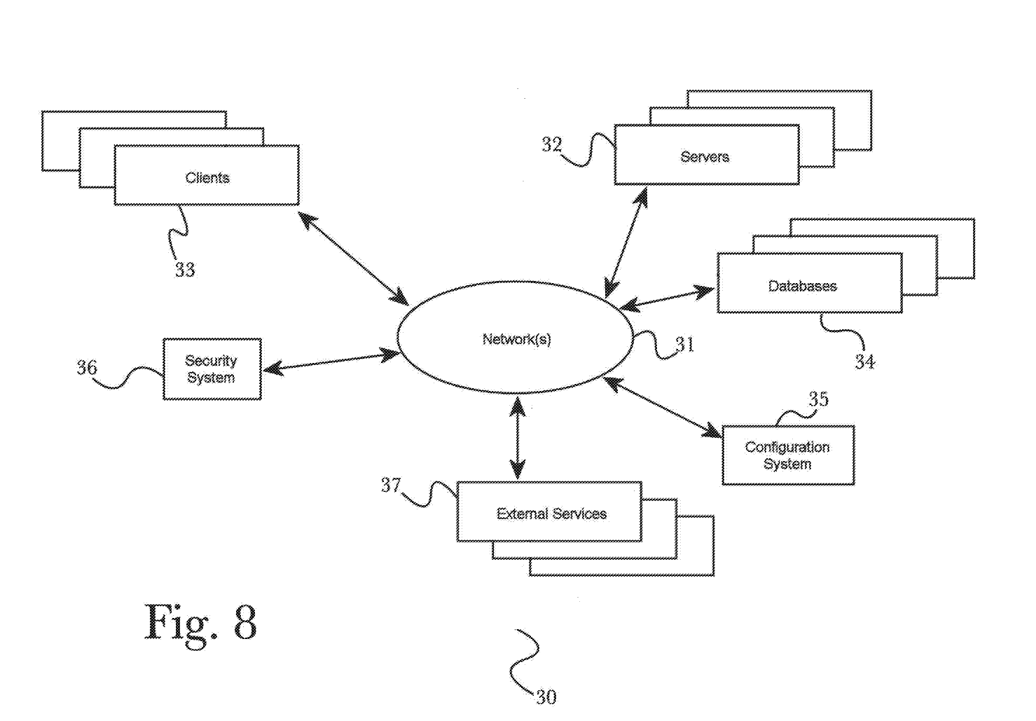

In some embodiments, systems of the present invention may be implemented on a distributed computing network, such as one having any number of clients and/or servers. Referring now to FIG. 8, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 7. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

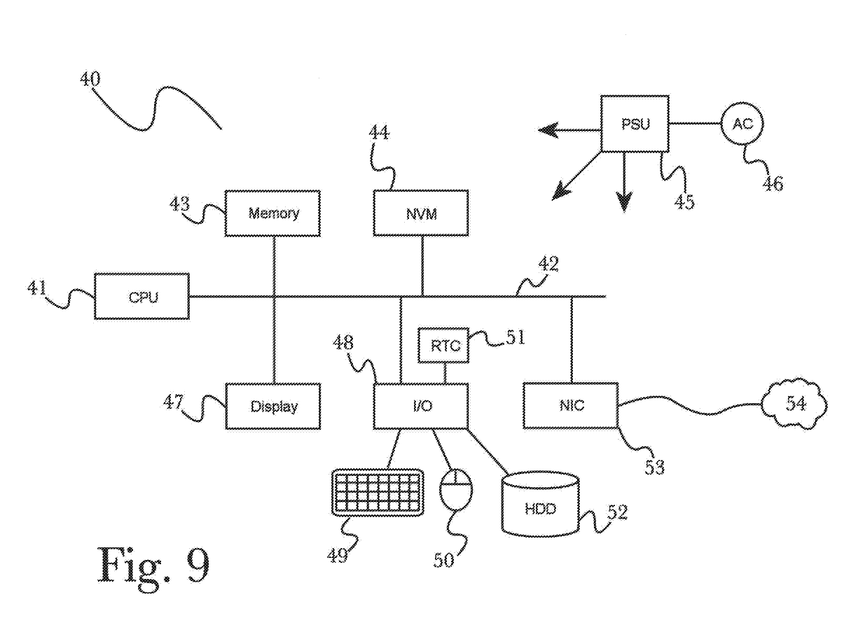

FIG. 9 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for automated patron food take-out management, comprising:
a patron management server comprising at least a plurality of programming instructions stored in a memory and operating on a processor of a network-connected computing device and configured to receive data via a network from a plurality of client devices, the data comprising at least geolocation information and a device identifier, and configured to retrieve patron information from a patron profile data store based at least in part on the device identifier;
a patron profile data store comprising at least a plurality of programming instructions stored in a memory and operating on a processor of a network-connected computing device and configured to store and provide patron information to other system components;
a mobile patron client comprising at least a plurality of programming instructions stored in a memory and operating on a processor of a mobile network-connected computing device and configured to communicate with patron management server to permit the exchange of a plurality of data types related to the order of take-out food items, the data types comprising at least geolocation information and a device identifier;
a food preparation manager comprising at least a plurality of programming instructions stored in a memory and operating on a processor of a network-connected computing device and configured at least to predict the actual preparation times of food items in the presence of a plurality of influencing factors, the influencing factors comprising at least geolocation information and the current state of a food preparation environment; and
a food preparation time data store comprising at least a plurality of programming instructions stored in a memory and operating on a processor of a network-connected computing device and configured to persistently store accurate baseline preparation times for a plurality of food items within a food preparation environment.

2. The system of claim 1, wherein at least a portion of the data exchanged between the patron management server and the mobile patron client are food types served by the take-out food venue.

3. The system of claim 1, wherein at least a portion of data exchanged between the patron management server and the mobile patron client is the location of take-out food venue.

4. The system of claim 1, wherein at least one mobile patron client communicates with at least two take-out food venue's patron management servers concurrently.

5. The system of claim 1, wherein at least a portion of the data exchanged between the mobile patron client and the patron management server is to determine a time delay factor resulting from take-out food pick-up from a route between two points entered into the mobile patron client.

6. The system of claim 5, wherein at least a portion of the time delay factor is predictively calculated by the food preparation manager resultant from food items ordered on the mobile patron client from a menu of take-out items supplied by the patron management server and current conditions at the venue's kitchen.

7. The system of claim 5, wherein at least a portion of the take-out items at at least one take-out food venue may be special order and require predictive calculation by the food preparation manager for accurate delay factor.

8. The system of claim 1 wherein, the food preparation manager is used to predictively queue all constituent food items in the take-out order for preparation so as to be ready at the same time and just prior to take-out patron arrival.

9. A method for automated patron food take-out management, comprising the steps of:
receiving, at a patron management server comprising at least a plurality of programming instructions stored in a memory and operating on a processor of a network-connected computing device and configured to receive data via a network from a plurality of client devices, the data comprising at least geolocation information and a device identifier, and configured to retrieve patron information from a patron profile data store based at least in part on the device identifier, a device identifier and device geolocation information from a patron mobile client via the network;
retrieving, using a patron profile data store comprising at least a plurality of programming instructions stored in a memory and operating on a processor of a network-connected computing device and configured to store and provide patron information to other system components, a plurality of patron information based at least in part on the received device identifier;
receiving, at the patron management server at least two endpoints comprising a current location and an intended destination and a request for venues serving specific take-out food types from the patron mobile client;
calculating, employing a food preparation manager and data from a food preparation time data store, preparation times of ordered take-out food items accounting for the current situation in the preparing kitchen to increase accuracy; and
coordinating food item preparation start times using the food preparation manager such that all food items come out of preparation at the same time and take-out food orders are ready very shortly prior to patron pickup arrival.

10. The method of claim 9, wherein at least a portion of the data exchanged between the patron management server and the mobile patron client are food types served by the take-out food venue.

11. The method of claim 9, wherein at least a portion of data exchanged between the patron management server and the mobile patron client is the location of take-out food venue.

12. The method of claim 9, wherein at least one mobile patron client communicates with at least two take-out food venue's patron management servers concurrently.

13. The method of claim 9, wherein at least a portion of the data exchanged between the mobile patron client and the patron management server is to determine a time delay factor resulting from take-out food pick-up from a route between two points entered into the mobile patron client.

14. The method of claim 13, wherein the at least a portion of the time delay factor is predictively calculated by the food preparation manager resultant from food items ordered on the mobile patron client from a menu of take-out items supplied by the patron management server and current conditions at the venue's kitchen.

15. The method of claim 14, wherein at least a portion of the take-out items at at least one take-out food venue may be special order and require predictive calculation by the food preparation manager for accurate delay factor.

16. The method of claim 9 wherein, the food preparation manager is used to predictively queue all constituent food items in the take-out order for preparation so as to be ready at the same time and just prior to take-out patron arrival.
